(19) United States
(12) Patent Application Publication
(10) Pub. No.: US 2022/0351233 A1
(43) Pub. Date: Nov. 3, 2022

(54) IMAGE PROCESSING APPARATUS, IMAGE PROCESSING METHOD, AND PROGRAM

(71) Applicant: NEC Corporation, Minato-ku, Tokyo (JP)

(72) Inventors: Ryoko MOMMA, Tokyo (JP); Yaeko YONEZAWA, Tokyo (JP)

(73) Assignee: NEC Corporation, Minato-ku, Tokyo (JP)

(21) Appl. No.: 17/760,502

(22) PCT Filed: Sep. 11, 2020
(86) PCT No.: PCT/JP2020/034556

§ 371 Date: Mar. 15, 2022

(30) Foreign Application Priority Data
Sep. 25, 2019 (JP) 2019-174285

(51) Int. Cl. G06Q 30/02; G06V 10/20; G06V 10/56

(52) U.S. Cl. CPC G06Q 30/0235; G06V 10/255; G06V 10/56

(57) ABSTRACT

An image processing apparatus (10) is an apparatus processing an image including a shelf tag and includes an image processing unit (120) and a price attribute determination unit (130). By processing an image including a shelf tag, the image processing unit (120) determines a feature item, which is at least one of a first color being a color of at least a partial area of the shelf tag, a second color being a color of a character included in the shelf tag (such as a numeral indicating a price), the size of the character, and the size of the shelf tag. Further, by image processing (such as character recognition processing), the image processing unit (120) determines a price indicated on the shelf tag. The price attribute determination unit (130) determines an attribute of the price by using the aforementioned feature item. The attribute of the price includes at least being a regular price or being a time-limited price.

### TECHNICAL FIELD

The present invention relates to an image processing apparatus, an image processing method, and a program.

### BACKGROUND ART

A shelf tag (price tag) is provided on a shelf on which products are placed in a store. When information described on a shelf tag is incorrect, a customer and a clerk incorrectly recognize information about the product. Therefore, an apparatus reading information described on a shelf tag is desired. For example, Patent Document 1 describes an apparatus recognizing an indication on a shelf tag by processing a captured image of the shelf tag. Specifically, a Japanese Article Number (JAN) code and a price are indicated in different colors on a shelf tag. Then, a matching determination apparatus recognizes the JAN code and the price by using the colors and determines a correspondence between the recognized JAN code and the recognized price.

### RELATED DOCUMENT

### Patent Document

Patent Document 1: Japanese Patent Application Publication No. 2016-194834

### DISCLOSURE OF THE INVENTION

### Technical Problem

A price of an article such as a product may be reduced for a limited period at a store. In this case, an indication on a shelf tag needs to be changed to an indication indicating the limited period, and the shelf tag needs to be brought back to a regular indication after the period ends. However, when the changes are omitted, a customer incorrectly recognizes information about the article. In order to suppress such an incident, it is preferable to enable a person in charge to determine an attribute of a price (for example, whether the price is a regular price or a time-limited price) indicated on a shelf tag with a small amount of effort.

An object of the present invention is to enable determination of an attribute of a price (for example, whether the price is a regular price or a time-limited price) indicated on a shelf tag with a small amount of effort.

### Solution to Problem

The present invention provides an image processing apparatus including:

an image processing unit that determines, by processing an image including a shelf tag, feature items being a first color being a color of at least a partial area of the shelf tag, a second color being a color of a character included in the shelf tag, a size of the character, and a size of the shelf tag, and determines a price indicated on the shelf tag; and

a price attribute determination unit that determines an attribute of the price by using the feature items.

The present invention provides an image processing method including, by a computer:

by processing an image including a shelf tag, determining a feature item, which is at least one of a first color being a color of at least a partial area of the shelf tag, a second color being a color of a character included in the shelf tag, a size of the character, and a size of the shelf tag, and determining a price indicated on the shelf tag; and

determining an attribute of the price by using the feature item.

The present invention provides a program causing a computer to perform:

a function of, by processing an image including a shelf tag, determining a feature item, which is at least one of a first color being a color of at least a partial area of the shelf tag, a second color being a color of a character included in the shelf tag, a size of the character, and a size of the shelf tag, and determining a price indicated on the shelf tag; and

a function of determining an attribute of the price by using the feature item.

### Advantageous Effects of Invention

The present invention enables determination of an attribute of a price (for example, whether the price is a regular price or a time-limited price) indicated on a shelf tag with a small amount of effort.

### BRIEF DESCRIPTION OF THE DRAWINGS

FIG. 1 is a diagram illustrating a functional configuration of an image processing apparatus according to an example embodiment.

FIG. 2 is a diagram illustrating an example of information stored by a first storage unit.

FIG. 3 is a diagram illustrating an example of information stored by a second storage unit.

FIG. 4 is a block diagram illustrating a hardware configuration of the image processing apparatus.

FIG. 5 is a flowchart illustrating a first example of processing executed by the image processing apparatus.

FIG. 6 is a flowchart illustrating a second example of the processing executed by the image processing apparatus.

FIG. 7 is a flowchart illustrating a third example of the processing executed by the image processing apparatus.

FIG. 8 is a flowchart illustrating a fourth example of the processing executed by the image processing apparatus.

### DESCRIPTION OF EMBODIMENTS

An example embodiment of the present invention is described below by using drawings. Note that, in each drawing, similar components are given similar signs, and description thereof is omitted as appropriate.

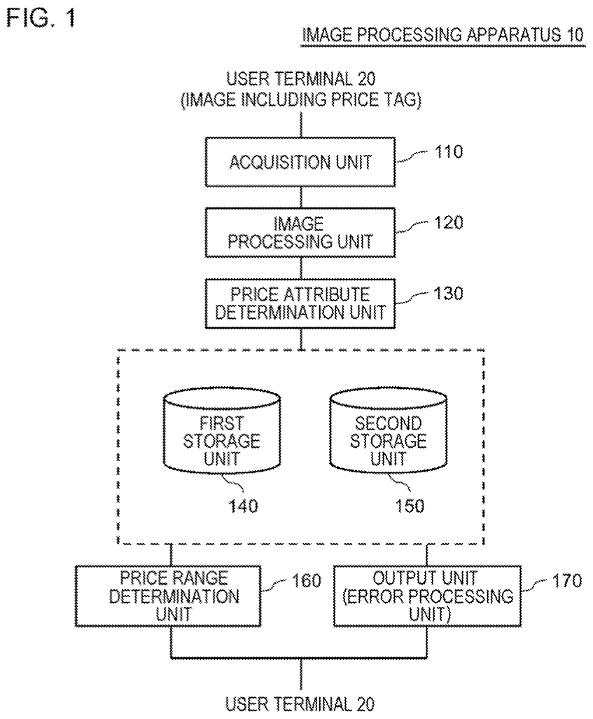

FIG. 1 is a diagram illustrating a functional configuration of an image processing apparatus 10 according to an example embodiment. The image processing apparatus 10 is an apparatus processing an image including a shelf tag and includes an image processing unit 120 and a price attribute determination unit 130. By processing an image including a shelf tag, the image processing unit 120 determines a feature item, which is at least one of a first color being a color of at least a partial area of the shelf tag, a second color being a color of a character included in the shelf tag (such as a numeral indicating a price), the size of the character, and the size of the shelf tag. Further, by image processing (such as character recognition processing), the image processing unit 120 determines a price indicated on a shelf tag. The price attribute determination unit 130 determines an attribute of a price by using at least one of the first color, the second color, the character size, and the shelf tag size, that is, the aforementioned feature item. An attribute of a price at least includes being a regular price or being a time-limited price. As an example, the price attribute determination unit 130 determines whether a price indicated on a shelf tag is a regular price or a time-limited price. The image processing apparatus 10 is described in detail below.

In addition to the aforementioned image processing unit 120 and the price attribute determination unit 130, the image processing apparatus 10 includes an acquisition unit 110, a first storage unit 140, a second storage unit 150, a price range determination unit 160, and an output unit 170.

The acquisition unit 110 acquires an image to be processed by the image processing unit 120, that is, an image including a price tag, from a user terminal 20. For example, the user terminal 20 is a portable terminal carried by a user of the image processing apparatus 10 and has an image capture function. The user generates an image by capturing an image of a shelf in the store. The image includes an article (such as a product: hereinafter described as a product) placed on the shelf and a shelf tag. The user terminal 20 transmits the generated image to the image processing apparatus 10. Note that, along with the image, the user terminal 20 transmits information for determining the store where the shelf being an image capture target is installed (hereinafter described as store determination information) and a condition at the time of image generation (hereinafter described as a generation condition). The generation condition at least includes the generation date and time of the image. The acquisition unit 110 also receives the store determination information and the generation condition.

By processing an image transmitted by the user terminal 20, the image processing unit 120 determines at least one (preferably all) of a first color, a second color, a character size, and a shelf tag size that are described above. For example, by performing processing using a feature value, the image processing unit 120 determines an area of the shelf tag from the image. Then, by processing the determined area, the image processing unit 120 determines a first color, a second color, a character size, and a shelf tag size. While the first color is a color of at least a partial area of the shelf tag as described above, “at least a partial area” may refer to, for example, an edge of the shelf tag or may be the entire shelf tag. Note that at least part of the processing performed by the image processing unit 120 may be performed by using a result of machine learning.

Further, by performing character recognition processing on an area of a shelf tag, the image processing unit 120 determines the type of a product related to the shelf tag and a price of the product. For example, by determining a product name or a JAN code described on a shelf tag by character recognition processing, the image processing unit 120 determines the type of the product (such as the product name) related to the shelf tag. Further, the image processing unit 120 determines a price of the product by character recognition processing.

As described above, the price attribute determination unit 130 determines an attribute of a price described on a shelf tag. For example, the price attribute determination unit 130 previously stores a first color, a second color, a character size, and a shelf tag size for each price attribute. For example, in a case of a regular price, the first color and the second color are black, and ranges of the character size and the shelf tag size are on a relatively small side. On the other hand, in a case of a time-limited price, the first color and the second color are a warm color (such as red or orange), and the character size and the shelf tag size are large relative to the case of a regular price.

Further, only the character size may be different between a regular price and a time-limited price, and only the color may be different. Then, the price attribute determination unit 130 determines an attribute of a price by using the previously stored information, and the first color, the second color, the character size, and the shelf tag size that are determined by the image processing unit 120.

The first storage unit 140 stores an attribute of a price determined by the price attribute determination unit 130 in association with a store indicated by store determination information acquired by the acquisition unit 110. Further, the price attribute determination unit 130 also stores information generated by the image processing unit 120. Note that the first storage unit 140 stores information indicating a transition of the information.

For each store and each product type, the second storage unit 150 stores a regular price and a special price of the product. Each price may or may not have a range. For example, the second storage unit 150 is updated by a clerk of a store as appropriate.

For each store and each product type, the price range determination unit 160 determines a price range of the product for each price attribute (such as a price range of a regular price and a price range of a limited time price) by processing information stored by the first storage unit 140. For example, for each price attribute, the price range determination unit 160 generates a maximum value and a minimum value of a price in a predetermined period in the past as information for determining a price range and causes the first storage unit 140 to store the information as needed.

The output unit 170 reads information stored by the first storage unit 140 and outputs the information to the user terminal 20. Further, the output unit 170 also outputs predetermined information (such as warning information or error notification) to the user terminal 20 as needed. Details of the processing are described later by using flowcharts.

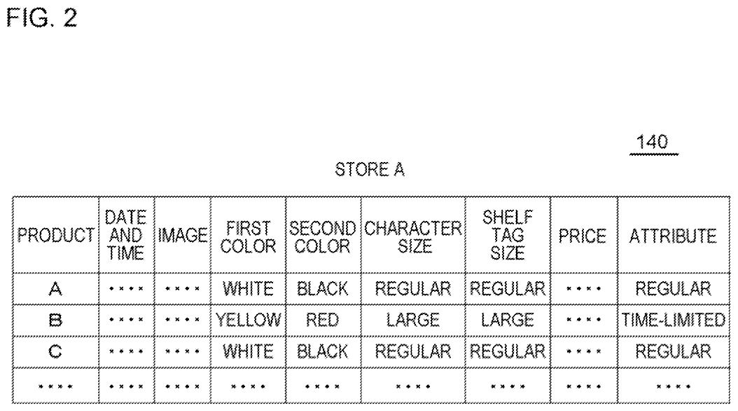

FIG. 2 is a diagram illustrating an example of information stored by the first storage unit 140. In the example illustrated in the diagram, for each store and each product, the first storage unit 140 stores an image processed by the image processing unit 120 and a generation condition (such as the generation date and time) of the image, a processing result by the image processing unit 120, and a processing result by the price attribute determination unit 130. For example, the processing result by the image processing unit 120 includes a first color, a second color, a character size, a shelf tag size, and a price that are described above. The processing result by the price attribute determination unit 130 includes an attribute of the price. Further, while not being illustrated, the first storage unit 140 also stores history data (log data) of the information described above. Furthermore, the first storage unit 140 also stores a price range [such as a maximum value and a minimum value of a price in a predetermined period (such as one year) in the past] for each price attribute determined by the price range determination unit 160.

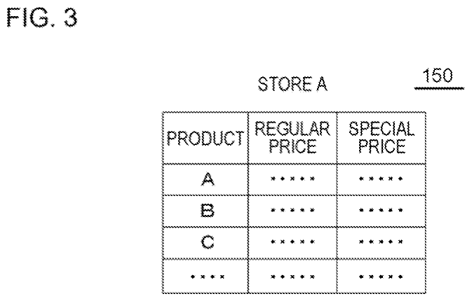

FIG. 3 is a diagram illustrating an example of information stored by the second storage unit 150. As described above, for each store and each product type, the second storage unit 150 stores a regular price and a special price of the product.

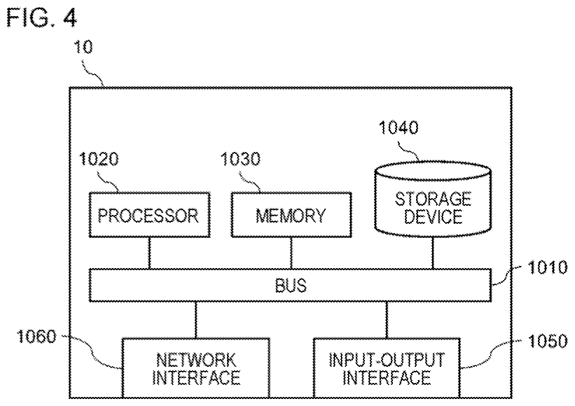

FIG. 4 is a block diagram illustrating a hardware configuration of the image processing apparatus 10. The image processing apparatus 10 includes a bus 1010, a processor 1020, a memory 1030, a storage device 1040, an input-output interface 1050, and a network interface 1060.

The bus 1010 is a data transmission channel for the processor 1020, the memory 1030, the storage device 1040, the input-output interface 1050, and the network interface 1060 to transmit and receive data to and from each other. Note that the method for interconnecting the processor 1020 and other components is not limited to a bus connection.

The processor 1020 is a processor provided by a central processing unit (CPU), a graphics processing unit (GPU), or the like.

The memory 1030 is a main storage provided by a random access memory (RAM) or the like.

The storage device 1040 is an auxiliary storage provided by a hard disk drive (HDD), a solid state drive (SSD), a memory card, a read only memory (ROM), or the like. The storage device 1040 stores program modules providing the functions of the image processing apparatus 10 (such as the acquisition unit 110, the image processing unit 120, the price attribute determination unit 130, the price range determination unit 160, and the output unit 170). By reading each program module into the memory 1030 and executing the program module by the processor 1020, each function related to the program module is provided. Further, the storage device 1040 also functions as various storage units (such as the first storage unit 140 and the second storage unit 150).

The input-output interface 1050 is an interface for connecting the image processing apparatus 10 to various types of input-output equipment.

The network interface 1060 is an interface for connecting the image processing apparatus 10 to another apparatus on a network (such as the user terminal 20).

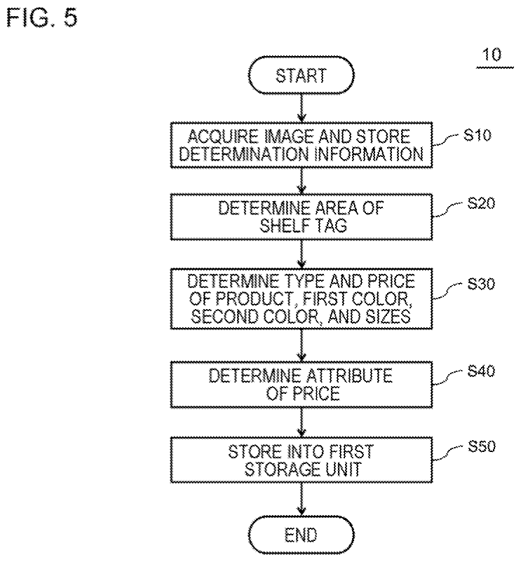

FIG. 5 is a flowchart illustrating a first example of processing executed by the image processing apparatus 10. The processing illustrated in the diagram is processing of determining an attribute of a price.

First, a user of the user terminal 20 captures an image of a product shelf in a desired store (such as a store where the user works or a store supervised by the user) and transmits an image generated by the image capture to the image processing apparatus 10 along with store determination information of the store and a generation condition (such as the generation date and time) of the image. The processing may be performed every time an image is generated. Further, the user of the user terminal 20 may capture images of locations different from each other in the product shelf and collectively transmit a plurality of images generated by the image capture to the image processing apparatus 10.

When the user terminal 20 transmits the image and the store determination information, the acquisition unit 110 in the image processing apparatus 10 acquires the image, the generation condition of the image, and the store determination information (Step S10). Then, the image processing unit 120 in the image processing apparatus 10 determines an area of a shelf tag by processing the image acquired by the acquisition unit 110 (Step S20). When a plurality of shelf tags are included in the image, the image processing unit 120 determines an area of each of the plurality of shelf tags. Next, the image processing unit 120 determines a first color, a second color, a character size, a shelf tag size, and a price that are described above by processing the determined area of the shelf tag (Step S30).

Next, the price attribute determination unit 130 determines an attribute of the price by processing the information determined in Step S30 (Step S40) and causes the first storage unit 140 to store the determined price (Step S50). At this time, the image processing unit 120 or the price attribute determination unit 130 also causes the first storage unit 140 to store the image being a processing target and the generation condition (such as the generation date and time) of the image, and the first color, the second color, the character size, the shelf tag size, and the price that are generated by the image processing unit 120.

Note that, when areas of a plurality of shelf tags are determined in Step S20, the processing described in Step S30 to Step S50 is performed on each of the areas of the plurality of shelf tags.

Further, when a plurality of shelf tags are included in one image, the price attribute determination unit 130 may determine, in Step S40, an attribute of a price on a first shelf tag by using a feature item, which is at least one of the first color, the second color, the character size, and the shelf tag size of a shelf tag of a first product, and feature items of a shelf tag of a second product being the first color, the second color, the character size, and the shelf tag size.

For example, in a case of an attribute of the price of the second product being determined to be a regular price, when all of the first color, the second color, the character size, and the shelf tag size of the shelf tag of the first product match the first color, the second color, the character size, and the shelf tag size of the shelf tag of the second product, the price attribute determination unit 130 determines that the price of the first product is a regular price. On the other hand, when at least one of the first color, the second color, the character size, and the shelf tag size is different, the price attribute determination unit 130 determines that the price of the first product is a time-limited price.

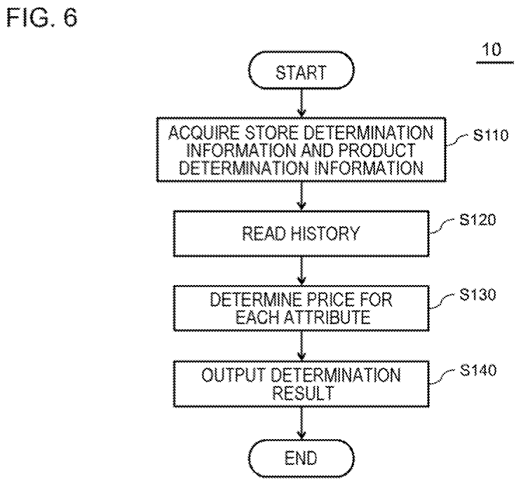

FIG. 6 is a flowchart illustrating a second example of the processing performed by the image processing apparatus 10. The processing illustrated in the diagram is processing of determining a price range for each store and each price attribute.

First, the price range determination unit 160 acquires store determination information and information for determining a product to be a target from the user terminal 20 (Step S110). Then, the price range determination unit 160 reads a history of a price related to a combination of the acquired store determination information and the acquired information for determining the product to be a target from the first storage unit 140 (Step S120) and determines a price range by using the read history (Step S130). An example of the processing is generating a maximum value and a minimum value of the price in a predetermined period in the past as information for determining a price range, as described above. The price range determination unit 160 may generate a maximum value and a minimum value of a predetermined ordinal number (such as second) as information for determining a price range.

Then, the price range determination unit 160 outputs the determination result to the user terminal 20 (Step S140).

Note that the price range determination unit 160 may perform the aforementioned determination processing of a price range on a predetermined store and a predetermined product (such as every store and every product) at a timing irrelevant to input from the user terminal 20 (for example, at regular intervals). In this case, the price range determination unit 160 causes the first storage unit 140 to store the determined price range tied to the store identification information, the information for determining the product, and the attribute of the price. Then, when receiving store identification information and information determining a product from the user terminal 20, the price range determination unit 160 reads, from the first storage unit 140, a price range for each attribute related to the received store identification information and the received information for determining a product and transmits the price range to the user terminal 20.

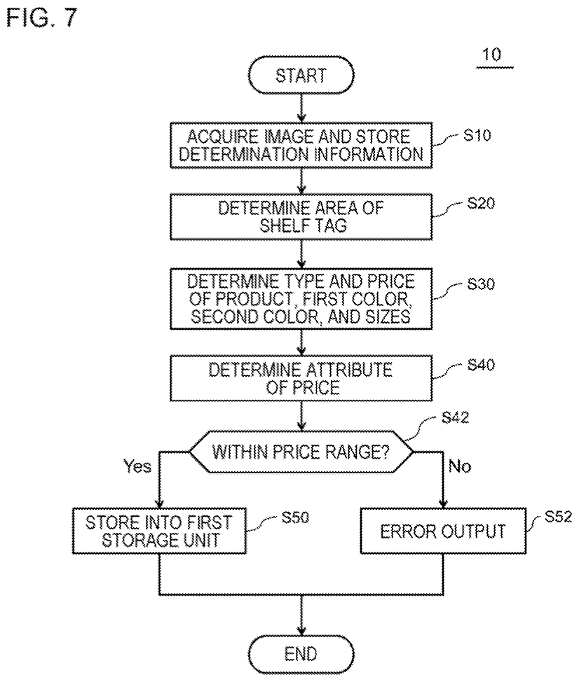

FIG. 7 is a flowchart illustrating a third example of the processing performed by the image processing apparatus 10. In the example illustrated in the diagram, the first storage unit 140 stores a price range for each attribute for each piece of store identification information and each product. Then, processing in Step S10 to S40 is similar to the example illustrated in FIG. 5.

When the price attribute determination unit 130 determines an attribute of a price (Step S40), the output unit 170 reads a price range related to a combination of store identification information, information for determining a product type, and the attribute of the price from the first storage unit 140. Then, the output unit 170 determines whether a price determined in Step S30 is within the read price range. When the price is within the price range (Step S42: Yes), the update processing of the first storage unit 140 is performed, similarly to the example illustrated in FIG. 5 (Step S50). On the other hand, when the price is out of the price range (Step S42: No), the price on the shelf tag may be incorrect, and therefore the output unit 170 performs predetermined output (such as error notification) to the user terminal 20 (Step S52). Thus, incorrect price setting can be suppressed.

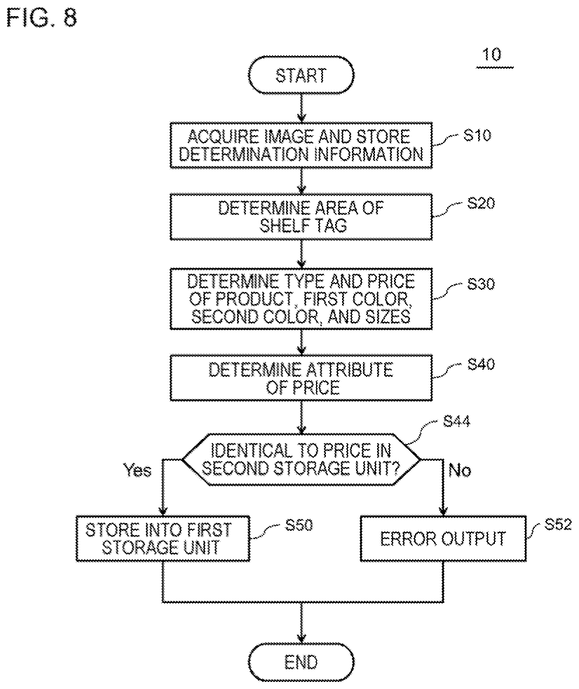

FIG. 8 is a flowchart illustrating a fourth example of the processing performed by the image processing apparatus 10. The example illustrated in the diagram is similar to the example illustrated in FIG. 7 except that Step S44 is performed in place of the processing described in Step S42.

In Step S44, the output unit 170 determines whether a price determined by the image processing unit 120 is identical to a price being stored in the second storage unit 150 in relation to an attribute determined by the price attribute determination unit 130. When the prices are identical (Step S44: Yes), the update processing of the first storage unit 140 is performed, similarly to the example illustrated in FIG. 5 (Step S50). When the prices are different, the price on the shelf tag may be incorrect, and therefore the output unit 170 performs predetermined output (such as error notification) to the user terminal 20 (Step S52). Thus, incorrect price setting can be suppressed.

Note that a time-limited price may not be stored in the second storage unit 150 in Step S44. Therefore, when a determination result by the price attribute determination unit 130 indicates time-limited and a time-limited price is not stored in the second storage unit 150, the output unit 170 compares the price determined by the image processing unit 120 with a regular price stored in the second storage unit 150. When the price determined by the image processing unit 120 is lower than the regular price, the image processing apparatus 10 advances to Step S50 and otherwise advances to Step S52.

As described above, the present example embodiment enables determination of an attribute of a price (such as a regular price or a time-limited price) indicated on a shelf tag with a small amount of effort. Therefore, omission of changing an indication on the shelf tag can be suppressed.

While the example embodiments of the present invention have been described above with reference to the drawings, the drawings are exemplifications of the present invention, and various configurations other than those described above may be employed.

Further, while a plurality of processes (processing) are described in a sequential order in each of a plurality of flowcharts used in the aforementioned description, an execution order of processes executed in each example embodiment is not limited to the described order. An order of the illustrated processes may be modified without affecting the contents in each example embodiment. Further, the aforementioned example embodiments may be combined without contradicting each another.

The whole or part of the example embodiments described above may also be described as the following supplementary notes but are not limited thereto.
1. An image processing apparatus including:

an image processing unit that determines, by processing an image including a shelf tag, a feature item, which is at least one of a first color being a color of at least a partial area of the shelf tag, a second color being a color of a character included in the shelf tag, a size of the character, and a size of the shelf tag, and determines a price indicated on the shelf tag; and

a price attribute determination unit that determines an attribute of the price by using the feature item.
2. The image processing apparatus according to aforementioned 1, wherein

the attribute includes at least being a regular price or being a time-limited price.
3. The image processing apparatus according to aforementioned 2, wherein

the image includes the shelf tag of a first article being a determination target of the attribute and the shelf tag of a second article at a regular price, and

the price attribute determination unit determines the attribute of the price on the first shelf tag by using the feature item of a shelf tag of the first article and the feature item of the shelf tag of the second article.
4. The image processing apparatus according to any one of aforementioned 1 to 3, wherein

the price attribute determination unit causes a first storage unit to store the price and the attribute in association with each other for each type of article,

the image processing apparatus further including

a price range determination unit that determines a price range of the article for the each attribute by using the price and the attribute that are stored in the first storage unit.
5. The image processing apparatus according to aforementioned 4, further including

an output unit that performs predetermined output when a price indicated on the shelf tag is out of the price range for the each attribute, the price range being related to the price.
6. The image processing apparatus according to any one of aforementioned 1 to 5, further including

an error processing unit that reads a price related to the attribute determined by the price attribute determination unit from a second storage unit that stores a price for the each attribute and performs error processing when the price is different from a price determined by the image processing unit.
7. An image processing method including, by a computer:

by processing an image including a shelf tag, determining a feature item, which is at least one of a first color being a color of at least a partial area of the shelf tag, a second color being a color of a character included in the shelf tag, a size of the character, and a size of the shelf tag and determining a price indicated on the shelf tag; and

determining an attribute of the price by using the feature item.
8. The image processing method according to aforementioned 7, wherein

the attribute includes at least being a regular price or being a time-limited price.
9. The image processing method according to aforementioned 8, wherein

the image includes the shelf tag of a first article being a determination target of the attribute and the shelf tag of a second article at a regular price,

the image processing method further including,

by the computer,

determining an attribute of the price on the first shelf tag by using the feature item of a shelf tag of the first article and the feature item of the shelf tag of the second article.
10. The image processing method according to any one of aforementioned 7 to 9, further including, by the computer:

causing a first storage unit to store the price and the attribute in association with each other for each type of article; and

further determining a price range of the article for the each attribute by using the price and the attribute that are stored in the first storage unit.
11. The image processing method according to aforementioned 10, further including, by the computer,

performing predetermined output when a price indicated on the shelf tag is out of the price range for the each attribute, the price range being related to the price.
12. The image processing method according to any one of aforementioned 7 to 11, further including, by the computer,

reading a price related to the attribute determined by the price attribute determination unit from a second storage unit that stores a price for the each attribute and performing error processing when the price is different from the determined price.
13. A program causing a computer to perform:

a function of, by processing an image including a shelf tag, determining a feature item, which is at least one of a first color being a color of at least a partial area of the shelf tag, a second color being a color of a character included in the shelf tag, a size of the character, and a size of the shelf tag and determining a price indicated on the shelf tag; and

a function of determining an attribute of the price by using the feature item.
14. The program according to aforementioned 13, wherein

the attribute includes at least being a regular price or being a time-limited price.
15. The program according to aforementioned 14, wherein

the image includes the shelf tag of a first article being a determination target of the attribute and the shelf tag of a second article at a regular price,

the program further causing the computer to determine the attribute of the price on the first shelf tag by using the feature item of the shelf tag of the first article and the feature item of the shelf tag of the second article.
16. The program according to any one of aforementioned 13 to 15, further causing the computer to:

store the price and the attribute in association with each other for each type of article into a first storage unit; and

further determine a price range of the article for the each attribute by using the price and the attribute that are stored in the first storage unit.
17. The program according to aforementioned 16, further causing the computer to

perform predetermined output when a price indicated on the shelf tag is out of the price range for the each attribute, the price range being related to the price.
18. The program according to any one of aforementioned 13 to 17, further causing the computer to

read a price related to the attribute determined by the price attribute determination unit from a second storage unit that stores a price for the each attribute and perform error processing when the price is different from the determined price.
19. An image processing apparatus including:

an image processing unit that determines, by processing an image including a shelf tag, price indicated on the shelf tag; and

an output unit that performs predetermined output when the price does not satisfy a predetermined criterion.

This application is based upon and claims the benefit of priority from Japanese Patent Application No. 2019-174285, filed on Sep. 25, 2019, the disclosure of which is incorporated herein in its entirety.

### REFERENCE SIGNS LIST

10 Image processing apparatus
20 User terminal
110 Acquisition unit
120 Image processing unit
130 Price attribute determination unit
140 First storage unit
150 Second storage unit
160 Price range determination unit
170 Output unit

What is claimed is:

1. An image processing apparatus comprising:\r
at least one memory storing instructions; and
at least one processor configured to execute the instructions to:
determine, by processing an image including a shelf tag, a feature item, which is at least one of a first color being a color of at least a partial area of the shelf tag, a second color being a color of a character included in the shelf tag, a size of the character, and a size of the shelf tag, and determines determine a price indicated on the shelf tag; and
determine an attribute of the price by using the feature item.

2. The image processing apparatus according to claim 1, wherein
the attribute includes at least being a regular price or being a time-limited price.

3. The image processing apparatus according to claim 2, wherein
the image includes the shelf tag of a first article being a determination target of the attribute and the shelf tag of a second article at a regular price, and
the at least one processor is further configured to execute the instructions to determine the attribute of the price on the shelf tag of the first article by using the feature item of the shelf tag of the first article and the feature item of the shelf tag of the second article.

4. The image processing apparatus according to claim 1, wherein the at least one processor is further configured to execute the instructions to:
cause a first storage to store the price and the attribute in association with each other for each type of article;
determine a price range of the article for the each attribute by using the price and the attribute that are stored in the first storage.

5. The image processing apparatus according to claim 4,
wherein the at least one processor is further configured to execute the instructions to output when a price indicated on the shelf tag is out of the price range for the each attribute being related to the price.

6. The image processing apparatus according to claim 1,
wherein the at least one processor is further configured to execute the instructions to read a price related to the determined attribute from a second storage that stores a price for the each attribute and perform error processing when the price is different from the determined price.

7. An image processing method comprising, by a computer:
by processing an image including a shelf tag, determining a feature item, which is at least one of a first color being a color of at least a partial area of the shelf tag, a second color being a color of a character included in the shelf tag, a size of the character, and a size of the shelf tag and determining a price indicated on the shelf tag; and
determining an attribute of the price by using the feature item.

8. The image processing method according to claim 7, wherein
the attribute includes at least being a regular price or being a time-limited price.

9. The image processing method according to claim 8, wherein
the image includes the shelf tag of a first article being a determination target of the attribute and the shelf tag of a second article at a regular price,
the image processing method further comprising,
by the computer,
determining an attribute of the price on the shelf tag of the first article by using the feature item of a shelf tag of the first article and the feature item of the shelf tag of the second article.

10. The image processing method according to claim 7, further comprising, by the computer:
causing a first storage to store the price and the attribute in association with each other for each type of article; and
further determining a price range of the article for the each attribute by using the price and the attribute that are stored in the first storage.

11. The image processing method according to claim 10, further comprising, by the computer,
performing predetermined output when a price indicated on the shelf tag is out of the price range for the each attribute being related to the price.

12. The image processing method according to claim 7, further comprising, by the computer,
reading a price related to the determined attribute from a second storage that stores a price for the each attribute and performing error processing when the price is different from the determined price.

13. A non-transitory computer readable medium storing a program, when executed by a processor of a computer, causing the computer to perform operations comprising:
by processing an image including a shelf tag, determining a feature item, which is at least one of a first color being a color of at least a partial area of the shelf tag, a second color being a color of a character included in the shelf tag, a size of the character, and a size of the shelf tag and determining a price indicated on the shelf tag; and
determining an attribute of the price by using the feature item.

14. The non-transitory computer readable medium according to claim 13, wherein
the attribute includes at least being a regular price or being a time-limited price.

15. The non-transitory computer readable medium according to claim 14, wherein
the image includes the shelf tag of a first article being a determination target of the attribute and the shelf tag of a second article at a regular price,
the program further causing the computer to determine the attribute of the price on the shelf tag of the first article by using the feature item of the shelf tag of the first article and the feature item of the shelf tag of the second article.

16. The non-transitory computer readable medium according to claim 13, further causing the computer to:
store the price and the attribute in association with each other for each type of article into a first storage; and
further determine a price range of the article for the each attribute by using the price and the attribute that are stored in the first storage.

17. The non-transitory computer readable medium according to claim 16, further causing the computer to
perform predetermined output when a price indicated on the shelf tag is out of the price range for the each attribute, the price range being related to the price.

18. The non-transitory computer readable medium according to claim 13, further causing the computer to
read a price related to the determined attribute from a second storage that stores a price for the each attribute and perform error processing when the price is different from the determined price.

19. (canceled)
